(19) United States
(12) Patent Application Publication
(10) Pub. No.: US 2015/0061951 A1
(43) Pub. Date: Mar. 5, 2015

(54) COMMUNICATION DEVICE AND SMALL-SIZE MULTI-BRANCH MULTI-BAND ANTENNA ELEMENT THEREIN

(71) Applicant: Acer Incorporated, New Taipei City (TW)

(72) Inventors: Kin-Lu Wong, New Taipei City (TW); Po-Wei Lin, New Taipei City (TW)

(73) Assignee: Acer Incorporated, New Taipei City (TW)

(21) Appl. No.: 14/084,242

(22) Filed: Nov. 19, 2013

(30) Foreign Application Priority Data
Sep. 3, 2013 (TW) 102131619

(51) Int. Cl. H01Q 9/04

(52) U.S. Cl. CPC H01Q 9/0407
USPC 343/749

(57) ABSTRACT

A communication device including a ground element and an antenna element is provided. The antenna element has a first connection point, and at least includes a first branch, a second branch, and a third branch. One end of the first branch is coupled through an inductive element to the first connection point. One end of the second branch is coupled to the first connection point. A second segment of the second branch is substantially parallel to a first segment of the first branch. The second branch is disposed between the first branch and an edge of the ground element. One end of the third branch is coupled to a second connection point on the first branch. The third branch and the first branch substantially extend in opposite directions. The first connection point is further coupled through a high-pass matching circuit to a signal source.

### CROSS REFERENCE TO RELATED APPLICATIONS

This Application claims priority of Taiwan Patent Application No. 102131619 filed on Sep. 3, 2013, the entirety of which is incorporated by reference herein.

### BACKGROUND OF THE INVENTION

1. Field of the Invention

The disclosure generally relates to a communication device, and more particularly, relates to a communication device comprising a small-size multi-branch multi-band antenna element.

2. Description of the Related Art

Mobile communication technology is progressing fast nowadays and playing a more and more important role in human life. Mobile communication devices need to operate in wider and wider bandwidths since each communication generation has different communication technique and each local telecommunication operator has different operation bands. Furthermore, in order to provide mobility and improve user experience, current mobile communication devices are designed to be thin and light. Hence, there are very limited spaces inside the device to accommodate the antenna elements. A conventional multi-branch multi-band LTE/WWAN (Long Term Evolution/Wireless Wide Area Network) antenna element, for example, has resonant paths as long as about a quarter wavelength of its operation frequency. Therefore, the conventional multi-branch multi-band antenna element occupies more spaces, and it is difficult to apply the conventional design to a variety of small-size mobile communication devices.

Furthermore, since the branches of the conventional multi-branch multi-band antenna element have adjacent resonant paths and need similar resonant lengths, the resonant modes excited by the branches tend to affect each other to result in degraded antenna performances. As a result, these resonant modes cannot be combined into a wide band to cover the desired operation bandwidth, or otherwise these resonant modes lead to low radiation efficiency even if appropriate impedance matching is obtained therebetween.

Accordingly, it is a critical challenge for antenna designers to design a low-profile, small-size, and wide-band multi-branch antenna element in the limited space of a mobile communication device to cover multiple operation bands (e.g., LTE/WWAN bands).

### BRIEF SUMMARY OF THE INVENTION

To solve the problems in the prior art, the invention provides a communication device comprising a multi-branch multi-band antenna element. This antenna element not only achieves a low-profile and small-size design but also covers LTE/WWAN bands (from about 704 MHz to 960 MHz and from about 1710 MHz to 2690 MHz) and a (Wireless Local Area Network) 2.4 GHz WLAN band.

In a preferred embodiment, the invention provides a communication device, comprising: a ground element; and an antenna element, disposed on a dielectric substrate, wherein the dielectric substrate is disposed adjacent to an edge of the ground element, the antenna element has a first connection point, and the antenna element at least comprises: a first branch, having a first length, wherein one end of the first branch is coupled through a first inductive element to the first connection point, the first branch comprises a first segment, and the first segment is substantially parallel to the edge of the ground element; a second branch, having a second length, wherein one end of the second branch is coupled to the first connection point, the second branch comprises a second segment, the second segment is substantially parallel to the first segment, and the second branch is disposed between the first branch and the edge of the ground element; and a third branch, having a third length, wherein one end of the third branch is coupled to a second connection point on the first branch, and the third branch and the first branch substantially extend in opposite directions; wherein the first connection point is further coupled through a high-pass matching circuit to a signal source, and the high-pass matching circuit has a grounding end coupled to the ground element.

The antenna element of the invention not only has a unique radiation structure (comprising the first branch, the second branch, and the third branch) but is also integrated with the high-pass matching circuit in such a manner that the antenna element has the advantages of low-profile, small-size, and wide-band characteristics. In some embodiments, the antenna element is configured to cover LTE/WWAN multiple bands. In some embodiments, the antenna element at least operates in a first band and a second band, and frequencies of the first band are lower than frequencies of the second band. Among the multiple branches of the antenna element, the second length may be shorter than the first length, and the third length may be shorter than the second length and is shorter than 0.5 times the first length. When the antenna element is fed by the signal source, the first branch may be excited to generate a first resonant mode in the first band, the second branch may be excited to generate a third resonant mode in the second band, and the third branch may be excited to generate a fourth resonant mode in the second band. The fourth resonant mode is combined with the third resonant mode to significantly increase the bandwidth of the second band.

In some embodiments, the high-pass matching circuit comprises at least a second inductive element coupled in parallel and a capacitive element coupled in series. In some embodiments, the high-pass matching circuit is disposed on the dielectric substrate or the ground element. The high-pass matching circuit is used to adjust the impedance matching of the antenna element. Since the second inductive element of the high-pass matching circuit may be further coupled to the ground element, the antenna element may perform like an inverted-F antenna structure and therefore have the advantage of low-profile characteristics. In some embodiments, the high-pass matching circuit causes the antenna element to further generate a second resonant mode in the first band. The second resonant mode is combined with the first resonant mode to significantly increase the bandwidth of the first band. The first inductive element can decrease the resonant lengths of the first branch and the third branch such that the antenna element has the advantage of small-size characteristics. In addition, when the antenna element operates in the second band, the first inductive element can isolate the first branch and reduce the coupling effect of the first branch on the third resonant mode excited by the second branch, such that the third resonant mode can be well excited. On the other hand, since the third branch is coupled to the first branch and the third length is shorter than 0.5 times the first length, the generation of the fourth resonant mode and the generation of the first resonant mode do not affect each other, and therefore both can be well excited. In some embodiments, the antenna element with a small-size planar structure (e.g., 10 mm by 40 mm) generates the wide first and second bands (e.g., from about 704 MHz to 960 MHz and from about 1710 MHz to 2690 MHz). Therefore, the antenna element is at least configured to cover the LTE/WWAN bands and the 2.4 GHz WLAN band.

### BRIEF DESCRIPTION OF DRAWINGS

The invention can be more fully understood by reading the subsequent detailed description and examples with references made to the accompanying drawings, wherein:

FIG. 1 is a diagram for illustrating a communication device according to a first embodiment of the invention;

FIG. 2 is a diagram for illustrating a communication device according to a second embodiment of the invention;

FIG. 3 is a diagram for illustrating return loss of an antenna element of a communication device according to a first embodiment of the invention;

FIG. 4 is a diagram for illustrating antenna efficiency of an antenna element of a communication device according to a first embodiment of the invention; and

FIG. 5 is a diagram for illustrating a communication device according to a third embodiment of the invention.

### DETAILED DESCRIPTION OF THE INVENTION

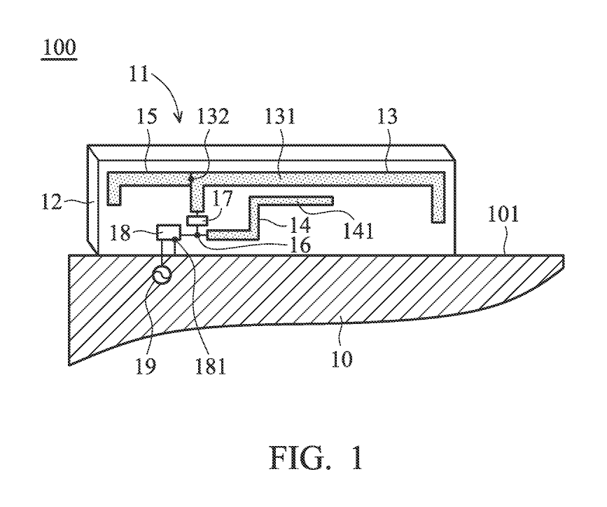

FIG. 1 is a diagram for illustrating a communication device 100 according to a first embodiment of the invention. The communication device 100 may be a smartphone, a tablet computer, or a notebook computer. As shown in FIG. 1, the communication device 100 at least comprises a ground element 10 and an antenna element 11. The ground element 10 may be a metal plane configured to accommodate some electronic components (not shown) of the communication device 100. In some embodiments, the communication device 100 may further comprise a dielectric substrate 12, a first inductive element 17, a high-pass matching circuit 18, and a signal source 19. The dielectric substrate 12 may be an FR4 (Flame Retardant 4) substrate. The first inductive element 17 may be a chip inductor. The high-pass matching circuit 18 may comprise one or more capacitors and inductors, such as chip capacitors and chip inductors. The signal source 19 may be an RF (Radio Frequency) module configured to excite the antenna element 11. The antenna element 11 is disposed on the dielectric substrate 12. The dielectric substrate 12 is disposed adjacent to an edge 101 of the ground element 10. The antenna element 11 has a first connection point 16, and at least comprises a first branch 13, a second branch 14, and a third branch 15. The first branch 13 has a first length. One end of the first branch 13 is coupled through the first inductive element 17 to the first connection point 16. The first branch 13 comprises a first segment 131, and the first segment 131 is substantially parallel to the edge 101 of the ground element 10. In some embodiments, the first branch 13 substantially has an inverted L-shape, and a combination of the first branch 13 and the third branch 15 substantially has an inverted U-shape. The second branch 14 has a second length. In some embodiments, the second length is shorter than the first length. One end of the second branch 14 is coupled to the first connection point 16. The second branch 14 comprises a second segment 141, and the second segment 141 is substantially parallel to the first segment 131 of the first branch 13. The second branch 14 is disposed between the first branch 13 and the edge 101 of the ground element 10. In some embodiments, the second branch 14 substantially has an inverted N-shape. The third branch 15 has a third length. In some embodiments, the third length is shorter than the second length, and is shorter than 0.5 times the first length. One end of the third branch 15 is coupled to a second connection point 132 on the first branch 13. The third branch 15 and the first branch 13 substantially extend in opposite directions. In other words, an open end of the third branch 15 is away from an open end of the first branch 13. In some embodiments, the third branch 15 substantially has an inverted L-shape. The first connection point 16 of the antenna element 11 is further coupled through the high-pass matching circuit 18 to the signal source 19. The high-pass matching circuit 18 has a grounding end 181, and the grounding end 181 is coupled to the ground element 10. Note that the communication device 100 may further comprise other components, such as a touch panel, a processor, a speaker, a battery, and a housing (not shown).

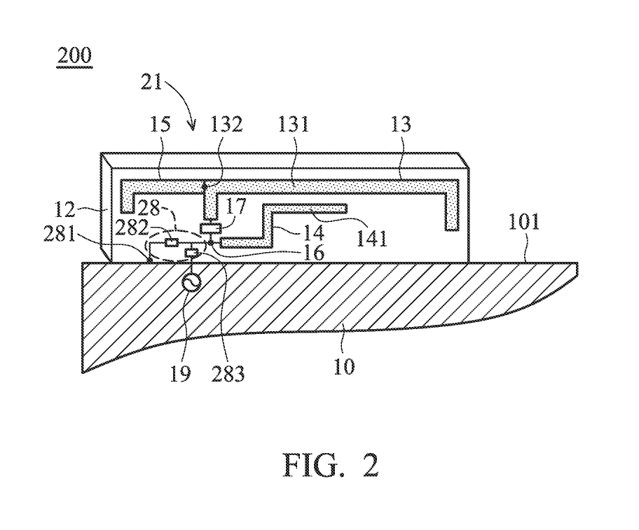

FIG. 2 is a diagram for illustrating a communication device 200 according to a second embodiment of the invention. The main difference between the second embodiment and the first embodiment is that a high-pass matching circuit 28 of the communication device 200 comprises at least a second inductive element 282 coupled in parallel and a capacitive element 283 coupled in series. More particularly, a first end of the second inductive element 282 is a grounding end 281 coupled to the ground element 10, and a second end of the second inductive element 282 is coupled to the first connection point 16. On the other hand, a first end of the capacitive element 283 is coupled to the signal source 19, and a second end of the capacitive element 283 is coupled to the first connection point 16. The second inductive element 282 may be a chip inductor, and the capacitive element 283 may be a chip capacitor. Other features of the communication device 200 of the second embodiment are similar to those of the communication device 100 of the first embodiment. Accordingly, the two embodiments can achieve similar performances.

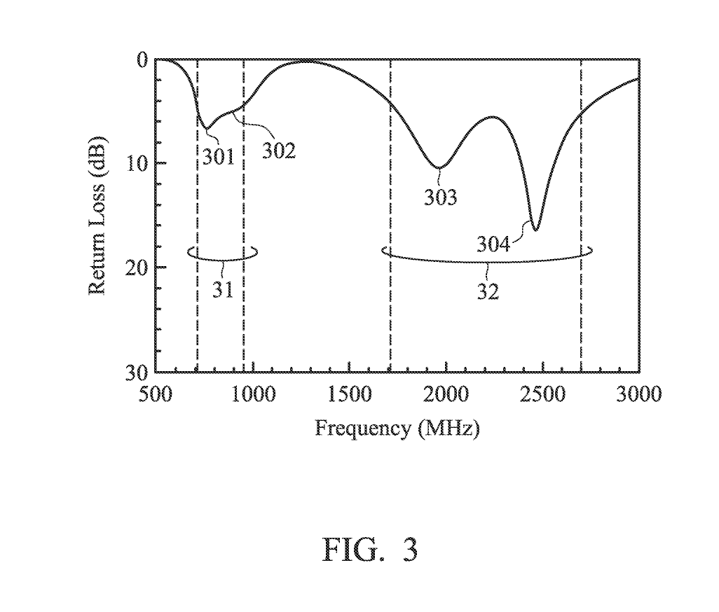

FIG. 3 is a diagram for illustrating return loss of the antenna element 11 of the communication device 100 according to the first embodiment of the invention. In some embodiments, the element sizes and element parameters of the communication device 100 are as follows. The ground element 10 has a length of about 200 mm and a width of about 150 mm. The dielectric substrate 12 has a length of about 40 mm and a width of about 10 mm and a thickness of about 0.8 mm. The first branch 13 has a first length of about 44 mm. The second branch 14 has a second length of about 23 mm. The third branch 15 has a third length of about 16 mm (shorter than 0.5 times the first length of the first branch 13). The first inductive element 17 is a chip inductor, and the chip inductor has an inductance of about 10 nH. The high-pass matching circuit 18 comprises a chip inductor coupled in parallel and a chip capacitor coupled in series, in which the chip inductor has an inductance of about 10 nH, and the chip capacitor has a capacitance of about 2.7 pF. As shown in FIG. 3, the antenna element 11 at least operates in a first band 31 and a second band 32, and frequencies of the first band 31 are lower than frequencies of the second band 32. More particularly, the operation principle of the antenna element 11 is described as follows. The first branch 13 of the antenna element 11 is excited to generate a first resonant mode 301 in the first band 31. The high-pass matching circuit 18 of the antenna element 11 is excited to generate a second resonant mode 302 in the first band 31. After the first resonant mode 301 is combined with the second resonant mode 302, the first band 31 substantially covers the LTE700/GSM850/GSM900 bands (from about 704 MHz to 960 MHz). In addition, the second branch 14 of the antenna element 11 is excited to generate a third resonant mode 303 in the second band 32. The third branch 15 of the antenna element 11 is excited to generate a fourth resonant mode 304 in the second band 32. After the third resonant mode 303 is combined with the fourth resonant mode 304, the second band 32 substantially covers the GSM1800/GSM1900/UMTS/LTE2300/LTE2500 bands (from about 1710 MHz to 2690 MHz) and the 2.4 GHz WLAN band.

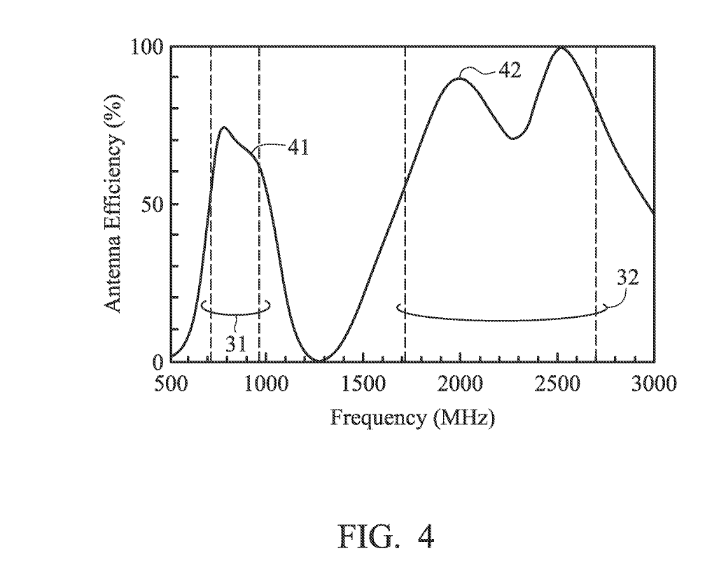

FIG. 4 is a diagram for illustrating the antenna efficiency of the antenna element 11 of the communication device 100 according to the first embodiment of the invention. The element sizes and element parameters of the communication device 100 may be the same as those described in the embodiment of FIG. 3. The antenna efficiency curve 41 represents the antenna efficiency (return losses included) of the antenna element 11 operating in the first band 31 (from about 704 MHz to 960 MHz). The antenna efficiency curve 42 represents the antenna efficiency (return losses included) of the antenna element 11 operating in the second band 32 (from about 1710 MHz to 2690 MHz). As shown in FIG. 4, the average antenna efficiency of the antenna element 11 is greater than about 55% in the first band 31, and the average antenna efficiency of the antenna element 11 is greater than about 60% in the second band 32. Therefore, the antenna efficiency meets the application requirements of mobile communication devices.

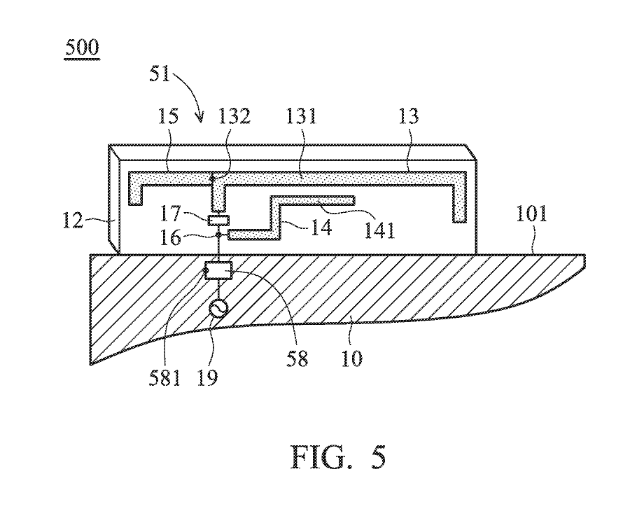

FIG. 5 is a diagram for illustrating a communication device 500 according to a third embodiment of the invention. The main difference between the third embodiment and the first embodiment is that a high-pass matching circuit 58 of the communication device 500 is disposed on the ground element 10, rather than the dielectric substrate 12. Other features of the communication device 500 of the third embodiment are similar to those of the communication device 100 of the first embodiment. Accordingly, the two embodiments can achieve similar performances.

Note that the aforementioned element sizes, element shapes, element parameters, and frequency ranges are not limitations of the invention. An antenna designer can change these values according to different requirements.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a ground element; and
an antenna element, disposed on a dielectric substrate, wherein the dielectric substrate is disposed adjacent to an edge of the ground element, the antenna element has a first connection point, and the antenna element at least comprises:
a first branch, having a first length, wherein one end of the first branch is coupled through a first inductive element to the first connection point, the first branch comprises a first segment, and the first segment is substantially parallel to the edge of the ground element;
a second branch, having a second length, wherein one end of the second branch is coupled to the first connection point, the second branch comprises a second segment, the second segment is substantially parallel to the first segment, and the second branch is disposed between the first branch and the edge of the ground element; and
a third branch, having a third length, wherein one end of the third branch is coupled to a second connection point on the first branch, and the third branch and the first branch substantially extend in opposite directions;
wherein the first connection point is further coupled through a high-pass matching circuit to a signal source, and the high-pass matching circuit has a grounding end coupled to the ground element.

2. The communication device as claimed in claim 1, wherein the high-pass matching circuit comprises at least a second inductive element coupled in parallel and

3. The communication device as claimed in claim 1, wherein the high-pass matching circuit is disposed on the dielectric substrate or the ground element.

4. The communication device as claimed in claim 1, wherein the second length is shorter than the first length.

5. The communication device as claimed in claim 1, wherein the third length is shorter than the second length and is shorter than 0.5 times the first length.

6. The communication device as claimed in claim 1, wherein the antenna element at least operates in a first band and a second band, and frequencies of the first band are lower than frequencies of the second band.

7. The communication device as claimed in claim 6, wherein the first branch is excited to generate a first resonant mode in the first band.

8. The communication device as claimed in claim 6, wherein the high-pass matching circuit causes the antenna element to further generate a second resonant mode in the second band to increase bandwidth of the first band.

9. The communication device as claimed in claim 6, wherein the second branch is excited to generate a third resonant mode in the second band.

10. The communication device as claimed in claim 6, wherein the third branch is excited to generate a fourth resonant mode in the second band to increase bandwidth of the second band.
